(19) United States
(12) Patent Application Publication
(10) Pub. No.: US 2002/0113455 A1
(43) Pub. Date: Aug. 22, 2002

(54) Fuel door cover for automotive vehicles

(76) Inventor: Jesse Mungia, Harvey, LA (US)

Correspondence Address: STREETS & STEELE, P.O. Box 1612, Cypress, TX, 77410-1612, US

(21) Appl. No.: 09/790,995

(22) Filed: Feb. 22, 2001

(51) Int. Cl. B62D 25/00

(52) U.S. Cl. 296/97.22

(57) ABSTRACT

A removable cover for the exterior surface of an automotive vehicle's fuel door. The cover has a securing means, such as one or more straps or fasteners, and a center portion, such as a fabric. Preferably, the cover is secured using a substantially circumferential elastic strap secured within one or more channels formed by folding and sewing the edges of the cover. The cover is designed to substantially cover the outwardly exposed exterior coated surface of the fuel door while avoiding interference with the operation of the fuel door hinges and locks. The cover is further suitable for displaying a message, symbol, logo or other visual display at a noticeable and highly visible location on the vehicle.

### FIELD OF THE INVENTION

This invention relates to fuel door protective covers for automotive vehicles. Specifically, this invention relates to covers for automotive vehicle fuel doors, and to covers for making vehicle fuel doors operable and easier to handle in extremely cold, icy or wet conditions.

### BACKGROUND OF THE RELATED ART

Original motorized vehicles using liquid fuel had exposed fuel tanks with upwardly turned fill tubes having a cap. As automotive engineers designed more aerodynamic and aesthetically pleasing vehicle exterior designs, fuel tanks were hidden from view by smooth exterior fenders, quarter panels and other body parts, but the fill tube of the gas tank extended through perforations in the exterior fender, quarter panels or other body parts. As automobiles continued to evolve, the end of the fill tube was recessed to terminate within the exterior surface of the vehicle exterior, and were accessed by opening small doors hinged to swing out of the closed position to expose the fill tube.

Fuel doors are commonly coated with the same paint and coating system used to coat the surrounding body part on the exterior surface of the vehicle so as to provide a smooth, continuous and unnoticeable access door at a convenient height and location for driver refueling. Increasingly, fuel doors are secured in the closed position during normal vehicle operation, and opened only when mechanically released by a switch or lever located inside the vehicle, usually near the driver's left side. Fuel doors are used upon each refueling of the vehicle, resulting in oil and dirt deposits on the fuel door and wear on the paint and finish from repeated contact by human hands. Also, fuel is often inadvertently spilled or sprayed on the fuel door, or on the hands that later touch the fuel door, and are harmful to the paint and finish of the vehicle.

Many people choose to display messages, symbols, designs, logos and other forms of communication on their vehicles. These messages may be of a business or commercial nature such as the logo or symbol of the vehicle manufacturer or commercial owner of a fleet vehicle, or of a personal nature such as the logo of a favorite sports team. The most prevalent manner of displaying such messages are bumper stickers.

There are several problems with using stickers on a vehicle exterior. Stickers are usually usable only once; that is, where more than one driver uses the vehicle, stickers cannot easily be removed by the driver that does not want to drive a vehicle bearing the sticker. Also, the sticker is generally permanent until removed; that is, it cannot be used seasonally or on special occasions when the message may be more appropriate. Stickers are also difficult to remove, especially after being on the vehicle for a prolonged time. When stickers are removed from a vehicle exterior, they often leave an unsightly, sticky residue on the exterior finish of the vehicle, and the paint underneath the location of the sticker will generally be noticeably less faded than the surrounding paint.

Many drivers display messages on banners or flags hanging from the antennae or other part of the vehicle, but antennae banners cause driver distraction, noise and undesirable antennae movement at high speeds or in high winds. Many drivers use outwardly facing signs or displays usually placed on the inside surface of the vehicle glass, often using suction cups for securing the display to the glass. These displays obstruct precious view and glass area within the vehicle, and may block the driver's view. Reversed stickers may be applied to the inside surface of the glass and readable from the outside, but these have the same problems as exterior stickers.

The problems with the existing methods and apparatus for displaying messages deter many from expressing themselves with a display on their vehicle, or from allowing others that may use their vehicle from displaying their messages. Seasonal or event-specific displays or messages are not usually made on vehicles because of the visible long-term effects on the appearance of the vehicle. What is needed is a way of allowing a driver to express or display a message that is temporary, that is, easily applied, removed and cleaned, and one that is not harmful to the exterior finish of the vehicle. This solution would even allow a non-owner driver to express seasonal or event-related messages while using the vehicle, and would leave no noticeable residue or scratches on the exterior finish of the vehicle.

More than any other part of the vehicle other than the door handle, the fuel door is touched by and handled by human hands. In the process, oils, moisture and dirt are transferred to the fuel door from the hands that open and close the fuel door. Also, fuel doors are generally made of the same metal that comprises the surrounding vehicle body part and may freeze in the closed position if the part becomes covered with ice. Unlike door handles, the shape of the fuel door is usually dictated primarily by aesthetics and not by ergonomics, and it can be difficult to manipulate during extreme cold, icy or wet conditions, especially when the human hands are also cold or wet. What is needed is a fuel door cover that prevents or deters ice formation on or around the fuel door. What is needed is a fuel door cover that makes the fuel door easier to grip and open during bad weather conditions, and one that protects the fuel door exterior surface from corrosion and fading of exterior paint on the fuel door caused by contaminants deposited on the fuel door by human hands.

“Message” as used herein means message, logo, display, symbol, letter, number, expression, emblem, trademark, sign, picture or other non-moving communication through visual means.

### SUMMARY OF THE INVENTION

The fuel door cover of the present invention provides a method and an apparatus for displaying messages at a highly visible location on the vehicle without using stickers or obstructing any view through vehicle glass. The fuel door cover of the present invention provides for easy installation and removal, it may be washable and may be made to allow interchangeable displays viewed through a transparent liner. The fuel door cover of the present invention deters deposit of oil, dirt and grease by human hands on the painted fuel door, and provides a strategically useful storage location for an electronically detectable transducer. The fuel door cover of the present invention deters or prevents ice formation or build-up on the fuel door of a vehicle during inclement weather, and generally makes the fuel door easier to manipulate in wet and cold weather.

The fuel door of a vehicle offers a strategically favorable place for temporarily or permanently displaying a message. The fuel door is usually in a position that is easily noticeable to the observer. For similar reasons, the fuel door is an ideal place to store electronically detectable transducers of the kind used in commercial transactions and traffic tolls. The present invention provides a method and apparatus for displaying a message on a vehicle without using stickers. The present invention also provides a method and apparatus for storing and presenting an electronically detectable transducer on the vehicle. The present invention provides a fuel door cover that protects and preserves the exterior coating on the fuel door of an automotive vehicle by resisting dirt and oil deposits that affect the exterior paint finish on the fuel door. The present invention provides a fuel door cover that deters freezing shut in bad weather, and a cover that that makes the fuel door easier to manipulate with bare or gloved human hands in cold or wet weather.

Increasingly, commercial transactions occur using electronically detectable transponders strategically placed on or in the vehicle for detection by strategically placed detectors. These transponders can be used at gas stations, drive-through windows at fast food restaurants, cleaners or banks, and the like. What is needed is a method and device for storing an electronically detectable transducer by the fuel door. The transponder stored within the fuel door cover can be used either to track the locations of the automobile using existing toll roads and traffic monitoring systems, or to enable or to prevent unwanted transactions in the presence of the vehicle where a detector is located and sensitive to the presence of the transponder.

It is desirable that the fuel door cover is easily removable and washable, and that it have a surface suitable for display of a message. It is also desirable that the fuel door cover be fitted to lay flat across the exterior flat portion of the fuel door, and that it is secured to the fuel door in a manner that does not interfere with either the hinge(s) or with latching or locking mechanisms common on many vehicles.

### BRIEF DESCRIPTION OF THE DRAWINGS

So that the features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows an embodiment of the fuel door cover installed on the fuel door of a typical automobile.

FIG. 2 shows an enlarged, frontal view of the fuel door cover of the present invention installed on the fuel door of a typical vehicle.

FIG. 3 shows an enlarged, frontal view of the fuel door cover of the present invention having a pocket formed between two sheets and installed on the fuel door of a typical vehicle.

FIG. 4 shows an enlarged, rear (inside) view of the fuel door cover of the present invention secured to a fuel door using straps and a clip fastener.

FIG. 5 shows an enlarged, rear (inside) fuel door cover of the present invention secured to a fuel door using a channel sewn into the fabric and a drawstring therein.

### DETAILED DESCRIPTION OF THE INVENTION

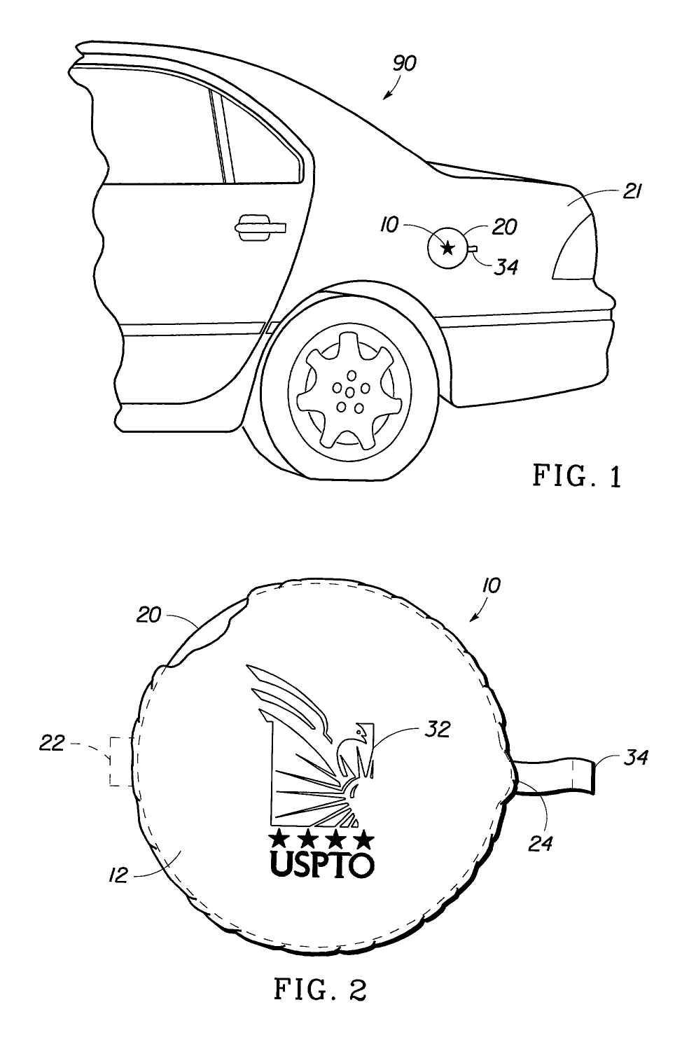

FIG. 1 shows the fuel door cover of the present invention installed onto the fuel door of a typical automobile. The fuel door cover in FIG. 1 is made of fabric or other materials. Fabric is generally a pliable material that can be easily sewn and adapted to fit snugly as a cover for many items, and fabric is the preferred material for making the fuel door cover of the present invention. Fabric is a material that can be stretched or drawn to provide a flat display portion in the center thereof. There are many methods of applying a message to fabric that are known in the art and embodied in T-shirts, banners, flags, ribbons and the like. Fabric may be selected for its particular compatibility with the application of messages to the display portion, or fabric can be manufactured to bear a selected message without post-manufacture application of the message. Fabric can also be pre-washed or treated with chemicals to make it water-resistant, luminescent, wrinkle resistant, fade resistant or shrink-resistant, and these fabric treatments are well known in the art. The display may be applied to the fuel door cover using an applique. As a result of all of these advantages, fabric is the preferred material for making the fuel door cover of the present invention.

The fuel door of the present invention is comprised of a sheet 12 of pliable material having a display portion 11 generally located in the center of the sheet 12. Some fuel doors are round, some are oval and some are of a rounded-rectangular shape, and the sheet of pliable material 12 should be cut to accommodate the size and shape of the fuel door to be covered. The amount of and dimensions of the sheet of material 12 used to make the fuel door cover of the present invention, whether fabric or other pliable material, may vary according to the physical dimensions and shape of the vehicle fuel door to be covered. In a preferred embodiment, the sheet of material 12 should be cut to provide a rounded sheet approximately 9.5 inches in diameter thereby providing a display portion 11 approximately 7 inches in diameter in the center thereof. The display portion 11 is to be disposed on the exterior side of the fuel door with the message or the applique visible to the observer when the fuel door is in its closed position shown in FIG. 1.

FIG. 2 shows an enlarged view of the display portion 11 of the fuel door cover 10, along with many of the components of the vehicle fuel door 20 and the fuel door cover 10. FIG. 2 shows an embodiment of the present invention adapted to cover the fuel door 20, the fuel doorbeing of a round shape, and having a hinge 22 located at one side of the fuel door 20 and a finger notch 24 at the opposite side of the fuel door 20. In the embodiment of the present invention shown in FIG. 2, the message is placed directly on the sheet 12 comprising the fuel door cover 10. The message may be applied to the sheet 12 according to the chemical and physical compatibility of the material comprising the message and the sheet 12, and includes printing, hot pressing, silk screening, embroidering, stitching, marking, writing, stamping, dyeing, adhering, staining, treating and other methods of imposing a visible message on the display portion 11 of the fuel door cover 10. Also included within the scope of the present invention is the application of chemicals or agents to the message or the display portion 11 of the sheet 12 for luminescence during darkness and photo-reactive chemicals.

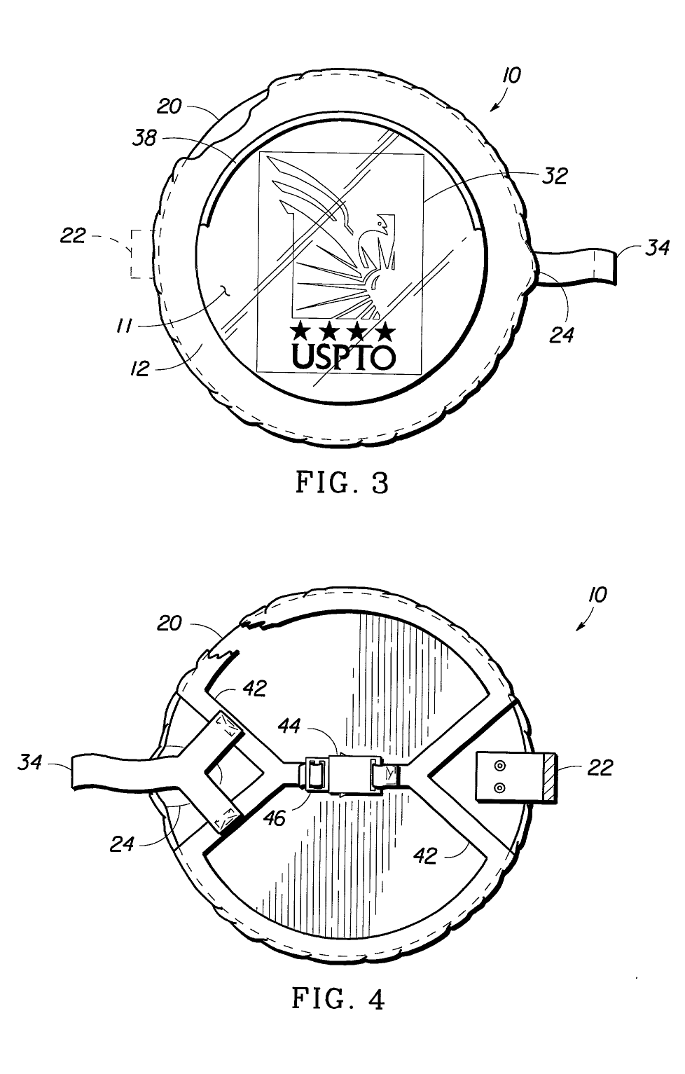

FIG. 3 shows one embodiment of the present invention having two sheets of material, the outside sheet being a transparent sheet 39 secured to the sheet 12 in the area of the display portion 11. The pocket 37 formed between the transparent sheet 39 and the sheet 12 can be used for inserting and displaying an interchangeable message. This embodiment allows the same fuel door cover to be used for different messages as opposed to the message being applied to the sheet 12 comprising the fuel door cover 20.

The fuel door cover of the present invention allows the use to display any message including, but not limited to logos and trademarks related to sports or music, seasonal and holiday symbols, political statements, humorous displays and the like, may be displayed on the display portion 11 disposed on the exterior side of the fuel door 20.

FIG. 4 shows one embodiment of the fuel door cover 20 having an arrangement of straps secured to the edge 52 of the sheet 12 to keep the display portion 11 of the sheet 12 generally flat and free of wrinkles. Keeping the display portion 11 generally flat makes the message on the display portion 11 more aesthetically pleasing and easy to read or view to the observer, and can generally be done by any securing means that generally draws substantial portions of the edge 52 of the sheet 12 inwardly toward the approximate center of the fuel door on the reverse (inside) side of the fuel door 20.

One embodiment of the fuel door cover securing means is shown in FIG. 4 along with the other components of the fuel door cover. The embodiment in FIG. 4 has an arrangement of four straps 42 secured at evenly distributed locations to the edge 52 of the sheet 12. Two opposing pairs of straps 42 are each secured together to form center straps 43, and the center straps 43 are secured to a hook 44, and the other to a loop 46, and one secured to the other near center of the reverse (inside) side of the fuel door by fastening the hook 44 and the loop 46. The arrangement of the straps 42 and the use of the hook 44 and loop 46 fastener are shown as a typical embodiment of the present invention, and other embodiments may use any arrangement of straps, drawstrings, elastic and fasteners. The fuel door cover 10 of the present invention can be secured to the fuel door 20 using a variety of securing means including clips, buckles, zippers, straps, strings or straps, Velcro™ or other hook-and-loop fasteners elastic ribbon, drawstrings or other securing means.

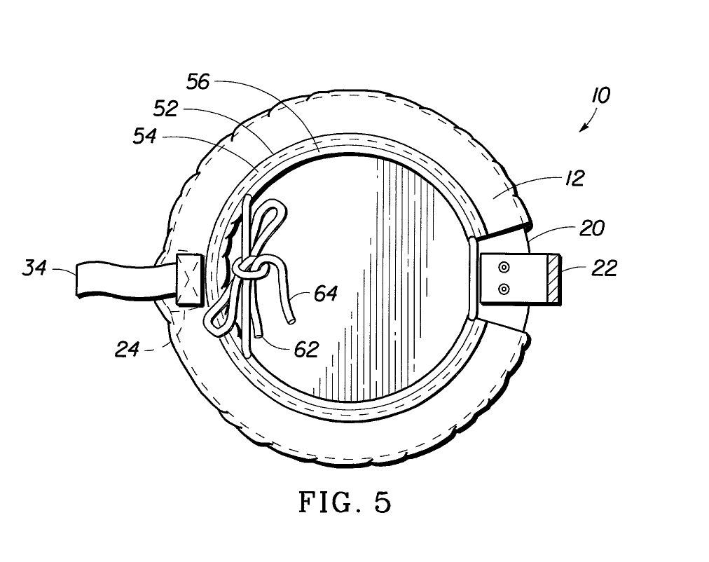

Another embodiment of the present invention shown in FIG. 5 shows two channels 56 formed by removing portions of the edge 52 of the sheet 12 adjacent to the hinge 22 and the pull tab 34, folding the remaining original edge 52 of the sheet 12 over onto itself, and then sewing or stitching the edge 52 of the sheet 12 to form two opposing channels 56. A drawstring 58 having a first end 62 and a second end 64 is threaded through the channels 56, pulled taught and tied one to the other. An alternative embodiment of the present invention substitutes a piece of elastic band or ribbon threaded through the channels 56 and then sewn one end to the other to form a substantially continuous elastic ring member in the place of the drawstring 58 shown in FIG. 5, the elastic member being of sufficient diameter and elasticity that it pulls the edge 52 of the sheet 12 sufficiently taught to secure the fuel door cover 10 to the fuel door 20 during high vehicle speeds and winds, and to allow easy removal of the fuel door cover 10 from the fuel door 20 by stretching the elastic ring member and slipping the edge 52 of the sheet 12 over the outer edge of the fuel door 20 and remove the fuel door cover 10 from the fuel door 20.

A message can be applied to the sheet 12 of material from which the fuel door cover 10 is made or, as shown in the embodiment in FIG. 3, it can be applied to a second sheet 39 of material, preferably paper or a decal, that can be inserted into a pocket 37 formed between the second sheet 39 and the sheet 12. The decal or second sheet 39 is inserted into and removed from the pocket 37 through a resealable flap 38, such as a Zip-loc™ seal. The water-tight or water-resistant seal prevents moisture and precipitation from entering the pocket 37 and compromising the appearance of the display or decal stored therein.

If the outwardly exposed portion of the fuel door cover 10 is a dark color that has a high sunlight absorption factor, the fuel door cover 10 will cause the fuel door 20 to remain at a higher temperature than the surrounding exterior body part due to insulation of the fuel door 20 by the fuel door cover 20 and to absorption and storing of heat energy during sunlight. Thus the fuel door cover 10 of the present invention deters freezing shut of the fuel door 20 during icy, wet and cold weather conditions. The sheet 12 comprising the fuel door cover 10 can be treated with chemicals or agents to impart high visibility, appearance and moisture resistance to prevent icing and wetness of the cover and to improve handling of the fuel door. The sheet 12 can also be chemically treated or otherwise manufactured in a way that promotes the adherence of any messages applied to the display portion 11 of the fuel door cover 20.

The fuel door cover 10 of the present invention can be used to store and conceal electronically detectable transducers which are becoming more and more common in electronically assisted commerce. Depending on the size and configuration of the transducer, and many are already as small as credit cards, it may be advantageous to store the transducer in a pocket 37 or other storage compartment sewn onto the inside of the fuel door cover 10. The electronically detectable transducer stored within the fuel door cover 10 in this manner is strategically placed for easy detection by any strategically located electronic detector. For example, detectors could be installed at gas stations and at fast food drive-throughs for improved efficiency in commercial transactions. The electronically detectable transducer could be used to debit an account for transactions completed from the vehicle, or it could be used in tandem with other transducers, credit cards or personal identification numbers or codes. A transaction might be enabled only by the presence of all needed transponders, credit cards, PINs and codes, and any failure to meet certain criteria or conditions, or failure of all needed transponders, credit cards, PINs or code numbers to be present, can defeat any transactions from the vehicle.

While the foregoing is directed to the preferred embodiment of the present invention, other and further embodiments of the invention may be devised without departing from the basic scope thereof, and the scope thereof is determined by the claims which follow.

I claim:

1. A removable cover for the fuel door of an automotive vehicle comprising a securing means and a center portion, the center portion being of sufficient size to substantially cover the exterior surface of the vehicle fuel door and secured to the fuel door by the securing means.

2. The cover of claim 1, wherein the center portion is a washable fabric.

3. The cover of claim 1, wherein the securing means comprises one or more straps.

4. The cover of claim 1, wherein the center portion is substantially surrounded by edges and wherein the securing means comprises a substantially circumferential elastic strap secured within one or more channels formed by folded and sewn edges.

5. The cover of claim 4, wherein the securing means comprises a substantially circumferential elastic strap of a relaxed length smaller than the perimeter of the fuel door.

6. The cover of claim 1, wherein the center portion is suitable for bearing an applique.

7. The cover of claim 1, wherein the center portion comprises a material that is suitable for application of a stable printed image.

8. The cover of claim 1, wherein the center portion forms a substrate onto which a display is applied.

9. The cover of claim 1, wherein the securing means comprises a hook and loop fastener.

10. The cover of claim 1, wherein the removable cover further comprises a transponder pocket for receiving an electronically detectable transponder that is detectable by, and can permit electronic information access by, electronically detecting sensors.

11. The cover of claim 12, wherein a second electronically detectable transponder is stored within the vehicle, and the local detection of the first and the second electronically detectable transponders electronically enables a commercial transaction to occur.

12. The cover of claim 13, wherein the second electronically detectable transponder is stored within the vehicle.

13. A method of protecting the coated finish of a fuel door comprising securing a flat piece of material to the fuel door to substantially cover the outwardly exposed exterior coated surface of the fuel door.

14. The method of claim 13, wherein said material comprises a washable fabric.

15. The method of claim 13, wherein the flat piece of protective material is secured to the door using two or more straps.

16. The method of claim 13, wherein the flat piece of material is circumferentially secured to the fuel door using a substantially circumferential, elastic band secured within one or more channels formed by folding and sewing one or more of the edges of the flat piece of material.

17. The method of claim 13, wherein the protective material is secured to the fuel door using a substantially, circumferential elastic band of a relaxed length smaller than the perimeter of the fuel door.

18. The method of claim 13, wherein the flat piece of material is secured to the fuel door using clips or clamps for gripping the edge of the flat piece of material against the edge of the vehicle fuel door.

19. The method of claim 13, wherein the flat piece of material is secured to the fuel door using hook and loop fastener.

20. The method of claim 13, wherein the jacket further comprises a transponder pocket containing a transponder that is detectable by, and can permit electronic information access by, electronic sensors.

21. A method of recording a transaction comprising:
attaching a detectable vehicle transponder the customer's vehicle,
providing the customer with a small, detectable personal transponder,
using sensors to detect the simultaneous presence within a given proximity of a fixed electronic transducer sensor of both the vehicle transponder and the personal transponder; and
crediting or debiting the customers' business account to record the transaction.

22. A method of attaching the vehicle transponder of claim 21 to the vehicle using a cover fitted onto the vehicle fuel door.

23. The cover of claim 1, wherein the cover further comprises a fabric tab extending from the cover opposite the fuel door hinge.

24. The cover of claim 23 wherein the fabric tab is fitted with a coupling used for attaching the cover to the fuel door.
